(19) United States
(12) Patent Application Publication
(10) Pub. No.: US 2008/0222764 A1
(43) Pub. Date: Sep. 18, 2008

(54) Flexible finger protectors

(76) Inventor: Christina Gard, Cape Coral, FL (US)

Correspondence Address: JAMES RAY & ASSOCIATES, 2640 PITCAIRN ROAD, MONROEVILLE, PA, 15146, US

(21) Appl. No.: 12/074,635

(22) Filed: Mar. 5, 2008

Related U.S. Application Data
(60) Provisional application No. 60/893,414, filed on Mar. 7, 2007.

(51) Int. Cl. A41D 13/08; B26B 13/00

(52) U.S. Cl. 2/21; 30/233

(57) ABSTRACT

A finger and knuckle guard for protecting a person's hands includes a substantially cylindrical hollow tube open at both a proximal and distal end and having a predetermined length, the hollow tube having flexible elastic walls of a predetermined thickness.

### CROSS REFERENCE TO RELATED APPLICATION

This patent application is related to and claims priority from U.S. Provisional Patent Application Ser. No. 60/893,414 filed Mar. 7, 2007.

### FIELD OF THE INVENTION

The present invention relates, in general, to safety devices for people cutting with scissors, and, more particularly, this invention relates to flexible finger and knuckle guards.

### BACKGROUND OF THE INVENTION

Prior to the conception and development of the present invention, barbers and hairdressers have had to endure cuts and nicks to their hands due to scissors and clippers straying slightly from their usual path. Many finger protection devices have been disclosed in the prior art. U.S. Pat. Nos. 4,689,828, 5,363,508, and 7,055,177 teach finger guards that cover and protect not just one or two fingers, but also the web area between the index and middle fingers. Some, such as U.S. Pat. Nos. 4,674,487 and 5,048,186, teach the use of substantially rigid bands that can be slipped over fingers. Some have disclosed semi-flexible sleeves that cover most of the finger, but leave a substantial opening for the knuckle of the main bending joint of the finger to allow for flexing at that joint, for example, those shown in U.S. Pat. Nos. 2,740,121 and 6,839,905. This design still leaves a vulnerable part of the finger unprotected. Similarly, the finger guard disclosed in U.S. Pat. No. 6,665,874 leaves nearly the whole backside of the finger exposed.

### SUMMARY OF THE INVENTION

The present invention provides a finger and knuckle guard for protecting a person's hands, and includes a substantially cylindrical hollow tube open at both a proximal and a distal end. The guard has a predetermined length sufficient to cover at least the main bending knuckle, and has flexible elastic walls of a predetermined thickness adequate to protect against scissor cuts, but not so thick as to inhibit bending of the knuckle joints. In an alternative embodiment, the interior of the hollow tube is cloth lined.

### OBJECTS OF THE INVENTION

It is, therefore, one of the primary objects of the present invention to provide convenient and effective safety devices for protecting the knuckles of barbers and hair stylists.

Another object of the present invention is to provide those cutting hair with finger protection from injury in an economical and simple form.

Still another object of the present invention is to provide effective finger protection devices that are inexpensive enough to be disposable, thereby offering greater personal hygiene.

Yet another object of the present invention is to provide finger protectors that are adaptable to many finger sizes.

An additional object of the present invention is to provide protection against nicks and cuts to a person's knuckles while still allowing significant bending at the primary knuckle joint.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective side close-up view of one finger protector.

FIG. 2 is a perspective view of a preferred embodiment of the invention in use during hair cutting.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

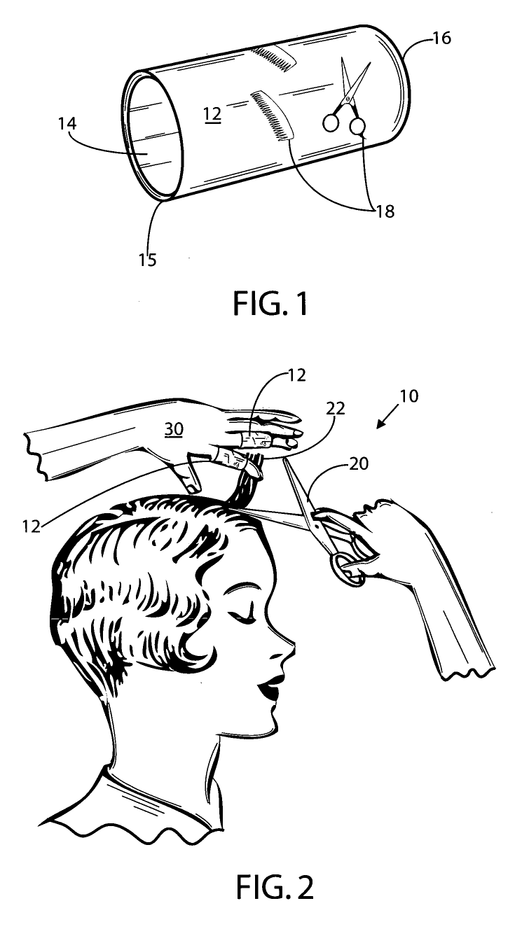

Referring initially to FIG. 1, a perspective view from the side is provided for the instant invention, generally indicated as 10. An cylindrical flexible tube 12 is constructed of a durable elastomeric material that can be stretched elastically in multiple directions in order to fit comfortably over many finger sizes. In order to provide significant cut protection, it has been determined that the elastomeric material should be at least 8 mils thick. However, in order to allow significant bending at the knuckles, the thickness of the wall 15 should generally be less that 40 mils (1.0 mm). The flexible tube is open at both a proximal end 14 and a distal end 16. While not essential, the diameter of the proximal end 14 may be slightly greater than that of the distal end 16 to account for the tapered nature of fingers. The elastomeric material forming the tube 12 may be one of many types of rubbers, plasticized polyvinyl chloride (PVC), polyolefin, or polyurethane. The elastomeric material may optionally be lined inside with a soft fabric for increased comfort. Also, the finger guards may optionally be decorated with indicia 18 relevant to a certain trade, such as combs and scissors for hair stylists.

The use of a preferred embodiment of the invention is generally shown as 10 in FIG. 2. A hair cutter's hand 30 has knuckle protectors 12 at the primary bending joint near the middle of both the middle and index fingers, which are the two generally used to hold hair 22 which is being cut by scissors 20. Protection will also be provided during use of electric clippers in lieu of the scissors.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A finger and knuckle guard for protecting a person's hand comprising:
a substantially cylindrical hollow tube open at both a proximal and distal end and having a predetermined length, said hollow tube having flexible elastic walls of a predetermined thickness.

2. The finger and knuckle guard, according to claim 1, wherein said predetermined length is between about two and six centimeters.

3. The finger and knuckle guard, according to claim 1, wherein said predetermined length is between about three and four centimeters.

4. The finger and knuckle guard, according to claim 1, wherein said predetermined thickness is between about 8 and 40 mils (0.2-1.0 mm).

5. The finger and knuckle guard, according to claim 1, wherein said proximal end has a slightly wider diameter than said distal end.

6. The finger and knuckle guard, according to claim 1, wherein said flexible elastic walls have an interior cloth lining.

7. The finger and knuckle guard, according to claim 1, wherein said cylindrical hollow tube is externally adorned with indicia.

8. In combination with a cutting instrument, the improvement comprising:
a finger and knuckle guard for protecting a person's hand having a substantially cylindrical hollow tube open at both a proximal and distal end and having a predetermined length, said hollow tube having flexible elastic walls of a predetermined thickness.

9. The combination, according to claim 8, wherein said predetermined length is between about two and six centimeters.

10. The combination, according to claim 8, wherein said predetermined length is between about three and four centimeters.

11. The combination, according to claim 8, wherein said predetermined thickness is between about 8 and 40 mils (0.2-1.0 mm).

12. The combination, according to claim 8, wherein said proximal end has a slightly wider diameter than said distal end.

13. The combination, according to claim 8, wherein said flexible elastic walls have an interior cloth lining.

14. The combination, according to claim 8, wherein said cylindrical hollow tube is externally adorned with indicia.
